(19) United States
(12) Patent Application Publication
(10) Pub. No.: US 2018/0339453 A1
(43) Pub. Date: Nov. 29, 2018

(54) Printer Sheets for Three Dimensional Printers and Related Methods of Using the Same

(71) Applicant: Douglas Alan DiNunzio, Fort Mill, SC (US)

(72) Inventor: Douglas Alan DiNunzio, Fort Mill, SC (US)

(21) Appl. No.: 15/989,505

(22) Filed: May 25, 2018

Related U.S. Application Data
(60) Provisional application No. 62/511,418, filed on May 26, 2017.

(51) Int. Cl. B29C 64/245; B33Y 30/00; C09J 7/30

(52) U.S. Cl. CPC B29C 64/245; C09J 7/30; B33Y 30/00

(57) ABSTRACT

Printer sheets are provided for securing printed objects to a print bed of a three-dimensional (3D) printer including a sheet of material configured to be secured to the print bed and provide consistent and even adhesion of a printed object to the print bed during printing and facilitate removal of the printed object upon completion of printing.

### CLAIM OF PRIORITY

The present application claims priority to U.S. Provisional Application No. 62/511,418, filed on May 26, 2017, entitled Printer Sheets For Three Dimensional Printers and Related Methods of Using the Same, the contents of which are hereby incorporated herein by reference as if set forth in its entirety.

### FIELD

The present inventive concept relates generally to three dimensional (3D) printers and, more particularly, to an accessory for a 3D printer in the form of a sheet for the printing surface or print bed and methods for using the same.

### SUMMARY

Some embodiments of the present inventive concept provide printer sheets for securing printed objects to a print bed of a three-dimensional (3D) printer including a sheet of material configured to be secured to the print bed and provide consistent and even adhesion of a printed object to the print bed during printing and facilitate removal of the printed object upon completion of printing.

In further embodiments, the printer sheet may include a first surface that contacts the print bed and a second surface that contacts the printed object. The printer sheet may further include a fastening mechanism on the first surface of the printer sheet to secure the printer sheet to the print bed.

In still further embodiments, the fastening mechanism may include an adhesive on the first surface of the printer sheet. The adhesive on the first surface of the printer sheet may include a removable cover thereon, the removable cover may be configured to be removed before the printer sheet is secured to the print bed. In certain embodiments, the adhesive on the first surface of the printer sheet may be activated by heat as the print bed is heated during printing. For example, the adhesive may be activated at a temperature of about 100 degrees Celsius.

In some embodiments, the printer sheet may be secured to the print bed using a fastening means separate from the printer sheet. The fastening means may include binder clips, clamps, adhesive tape and any combination thereof.

In further embodiments, the printer sheet may be secured to the print bed using a self-adhesive property of the printer sheet.

In still further embodiments, the printer sheet may include a first surface that contacts the print bed and a second surface that contacts the printed object. An adhesive material may be provided on the second surface of the printer sheet that contacts the printed object and secures the printed object during printing.

In some embodiments, the printer sheet may be a moderately flexible material.

In further embodiments, the material of the printer sheet may include at least one of a polymeric material, a plastic material, a polycarbonate material and a polymide material.

In still further embodiments, the printer sheet may be any size and shape smaller than the print bed.

In some embodiments, a size of the printer sheet may be customizable.

In further embodiments, the printer sheet may be configured to be used a limited number of times.

In still further embodiments, the printer sheet may be heat resistant.

In some embodiments, when secured to the print bed, the printer sheet may be smooth with no folds, wrinkles or ridges.

In further embodiments, the printer sheet may include a first surface that contacts the print bed and a second surface that contacts the printed object. The second surface may include at least one of a color, texture, design, letter and number that is configured to be transferred to the printed object during printing.

In still further embodiments, a plurality of printer sheets may be combined together in a package to be purchased by a user of the 3D printer.

### BACKGROUND

Three-dimensional (3D) printers, for example, those that utilize fusion deposition modeling (FDM) have gone from expensive systems only for those with sufficient business justification to now being within reach of the average consumer. Once thought to only be practical for businesses looking to accelerate their prototyping of new products, prices of 3D printers have plummeted and at the same time, the capabilities, practicality and ease of use of 3D printers have dramatically increased, and competition for this market has expanded worldwide. As 3D printers have evolved, so have the size of products than can be printed by these systems, as well as the materials that can be utilized by the same. These materials include, but are not limited to, for example, polylactide (PLA), Polyvinyl chloride (PVC), Polyethylene terephthalate (PETG), Acrylonitrile-Butadiene-Styrene (ABS), wood blend, glass blend, and even water soluble plastic (PVA), which is typically used for creating support for print objects with “overhangs” during the printing process. Industrial printers can print with even more sophisticated materials, including metal, or even human cells. As with most technologies, these advances will likely trickle down to the retail and consumer market.

The emergence of web sites such as Thingiverse (<www.thingiverse.com>), where users can surf through tens of thousands of free 3D print files designed by people around the world, and within minutes users can download these files and use the files to begin printing has further increased the popularity of 3D printers. Web sites such as Onshape (<www.onshape.com>) have made sophisticated computer aided design (CAD) software generally available to the public. Thus, the home or novice user can design products using features that were previously only made available in very expensive CAD software packages like, for example, SolidWorks. Now users can launch Onshape from any Windows or Android device, and as Onshape is cloud based, there may be no need install software or pay for expensive licenses to use the same.

The unfortunate reality is that 3D printing, for example, fused deposition modeling (FDM) 3D printing, typically requires that the user have a significant amount of experience to be able to produce an acceptable final product. The printing process involves the deposition of printing material onto a printing platform, also referred to as a “print bed.” The deposited material may be melted into a pliable state, extruded through a hot end/heated nozzle and built up, layer by layer, until the final result is a 3D object. Because the layers are deposited in sequence on top of each other, print success and quality depend upon the ability to maintain registration of the object with the extruder nozzle throughout the duration of the print job to ensure that each stacked layer registers with the previous one. As such, many problems can occur during the process, including, for example, clogged hot ends/heated nozzles, or debris forming or attaching on the hot end/heated nozzle, which end up deposited onto the object being printed, thus negatively affecting the structure or finish on the object. Moreover, it is not unusual for larger, more complex pieces to require twelve to fifteen, or more, hours to print. Thus, a significant amount of resources and time may be wasted if such issues arise late in the printing process. One of the most common challenges faced by users of 3D printers is, at the very beginning of the print job, when the printer lays down the initial plastic forming the base of the object. Often, the material forming the base of the object can break loose from the print bed either initially or in the formation of subsequent layers, leaving the user no alternative but to restart the process.

Manufacturers and users of FDM-type 3D printers often recommend covering the print bed surface with a heat resistant film, such as a polyimide film, and/or paper masking tape, typically used by painters and referred to as painter's tape, and/or pre-treating the surface with hairspray, special water-soluble glue, for example, from an Elmer's Glue Stick, or other liquid treatment solutions. These applications are intended to hold the 3D printed object to the surface while it is being printed and to preserve the longevity of the original print bed of the 3D printer. These print bed covering materials are intended to provide a removable and replaceable surface on which to print, and in some cases take the wear and tear that would otherwise be inflicted upon the print bed. Although these procedures work for the most part, they are not without problems, which can either negatively affect the finished product, or lead to the destruction thereof.

Although painter's tape will effectively adhere to the print bed, the application of painter's tape alone to the print bed is not sufficient to have the printed material adhere to it. A layer of glue is required to ensure adherence of the printed material to the layer of tape. However, adherence with the aid of glue is often excessive, and after the object has been printed and has cooled down, it can be difficult if not impossible to remove the object from the print bed. 3D printed objects can be easily damaged or completely destroyed when trying to remove them from the print bed. The more fragile the 3D printed object, the more likely it will be damaged. Lastly, the bottom side of the object by nature of how a 3D printer works will inherit the surface texture of whatever the surface is that it has been printed onto. In the case of tape with glue, the final product will end up with the surface texture of the tape, and will show the seams between the strips of tape across the print bed, and will even sometimes show where the glue stick was applied if the layers are thick and/or uneven. If, for example, the bottom side surface of the 3D printed object is the bottom of a vase, the texture of this surface is not critical. However it is virtually impossible to print something that needs to have a professional finish on the bottom surface of the 3D printed object. As such, there continues to be a need for improved products for securing 3D printed objects on the print bed of a 3D printer.

### BRIEF DESCRIPTION OF THE DRAWINGS

FIG. 1 is a diagram illustrating a 3D printer for use in accordance with some embodiments of the present inventive concept.

FIG. 2 is a diagram illustrating an FDM 3D printing process, in which painter's tape has been affixed to the print bed of the 3D printer and a 3D printed object is secured to the painter's tape by a water soluble glue.

FIG. 3 is a diagram of a print bed having a printer sheet thereon in accordance with some embodiments of the present inventive concept.

FIGS. 4 and 5 are diagrams illustrating printer sheets having textures in accordance with some embodiments of the present inventive concept.

### DETAILED DESCRIPTION

The present inventive concept will be described more fully hereinafter with reference to the accompanying figures, in which embodiments of the inventive concept are shown. This inventive concept may, however, be embodied in many alternate forms and should not be construed as limited to the embodiments set forth herein.

Accordingly, while the inventive concept is susceptible to various modifications and alternative forms, specific embodiments thereof are shown by way of example in the drawings and will herein be described in detail. It should be understood, however, that there is no intent to limit the inventive concept to the particular forms disclosed, but on the contrary, the inventive concept is to cover all modifications, equivalents, and alternatives falling within the spirit and scope of the inventive concept as defined by the claims. Like numbers refer to like elements throughout the description of the figures.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art to which this inventive concept belongs. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

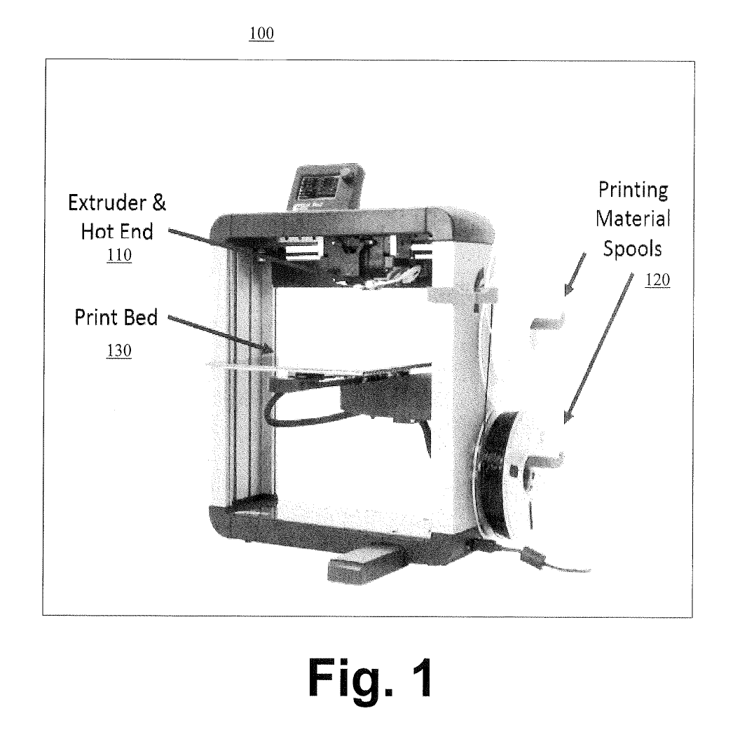

As discussed above, there continues to be a need for improved products for securing 3D printed objects on the print bed of a 3D printer. Accordingly, some embodiments of the present inventive concept provide a 3D “printer sheet” that can be disposed on the print bed of the 3D printer, which provides consistent/even adhesion of a 3D printed object to the print bed of the 3D printer on which the printer sheet may be disposed. Once the print job is complete, the presence of the printer sheet may allow the safe and easy removal of the 3D printed object without damaging or destroying the 3D printed object in the process. Some embodiments of the present inventive concept also provide printer sheets that apply a finished surface to a 3D printed object, for example, a printer sheet in accordance with embodiments discussed herein may impart a texture and/or transfer colors or designs to the surface of the 3D printed object as will be discussed further herein with respect to FIGS. 1 through 5.

As used herein the term “printer sheet” can be any material, any size and any shape that can be used to provide the benefits discussed herein with respect to embodiments of the present inventive concept. Thus, although the figures depict and the specification discussed particular materials, shapes and sizes, these are provided for example only and are not intended to limit embodiments of the present inventive concept. Furthermore, the finished product, i.e., the printed object, will be referred to herein as “the 3D printed object.”

Referring first to FIG. 1, a standard 3D printer for use in accordance with some embodiments of the present inventive concept will be discussed. As illustrated in FIG. 1, the 3D printer 100 may include an extruder and hot end 110, printing materials and spools 120 and a print bed 130. 3D printers in accordance with embodiments of the present inventive concept may have many forms without departing from the scope of the present inventive concept.

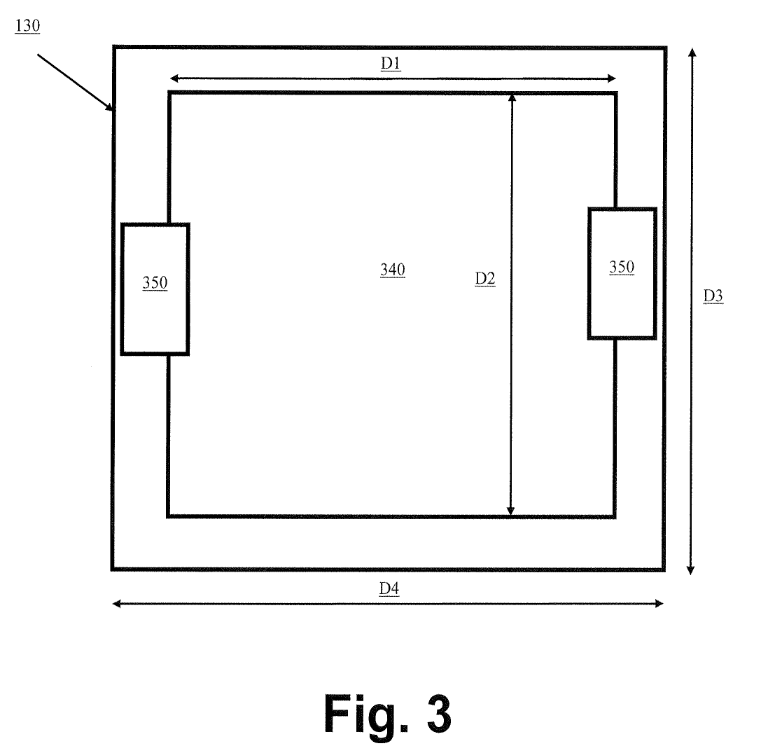

Referring now to FIG. 3, as illustrated in FIGS. 1 and 3, the print bed 130 is square in shape and may have dimensions D3×D4. In some embodiments, the dimensions of the print bed 130 are 12 by 12 inches, but embodiments of the present inventive concept are not limited to this configuration. For example, the print bed 130 may not be square and may have any feasible size and shape. As further illustrated in FIG. 3, a printer sheet in accordance with embodiments discussed herein may be smaller than the print bed 130. For example, as illustrated in FIG. 3, the printer sheet 340 has dimensions of D1×D2 and is placed on the print bed 130. Again, the dimensions of the printer sheet may be any suitable dimensions, but in some embodiments, the dimensions may be 9 inches by 9 inches.

Embodiments of the present inventive concept enhance the quality of 3D printed objects. In some embodiments, the printer sheet 340 is disposed on the print bed of a 3D printer such that the 3D printing process takes place on the printer sheet and the 3D printed object is provided thereon. As will be discussed further below, the presence of a printer sheet 340 in accordance with embodiments discussed herein addresses the issues present in conventional methods of distorted surfaces of the 3D printed object and the inability to remove the 3D printed object from the print bed. As discussed above, the size and shape of the printer sheet 340 is not particularly limited. However, the printer sheet 340 in general should be sized to cover, or substantially cover the print bed 130 of the 3D printer and be generally planar in form, and may generally be square or rectangular in shape. In some embodiments, the printer sheet 340 may be trimmed in size to fit on the print bed 130 of the 3D printer. In other embodiments, the printer sheet 340 of the present inventive concept may be a single use, or a finite number of uses, product, i.e., is a consumable item that is disposed of following completion of a print job, or after completion of a plurality of print jobs, for example, 2, 3, 4, 5, 6, 7, 8, 9, 10 print jobs, and the like.

The thickness of the printer sheet 340 and the material or materials from which the printer sheet is fabricated are not particularly limited, but generally, the thickness of the printer sheet is selected such that the printer sheet 340 has some flexibility, yet is sufficiently rigid to perform its function. The printer sheet 340 may include a polymeric or plastic material, for example, but not limited to, polycarbonate or polyimide. The printer sheet may include a surface that is in contact with the print bed of the 3D printer, and a surface on which the 3D printing process takes place and on which the 3D printed object is formed. In some embodiments, the printer film may be heat resistant, and include a material such as, for example, polyimide.

As further illustrated in FIG. 3, the printer sheet 340 is typically fastened to the print bed 130 using a fastening means 350. The fastening means 350 is used to fasten/attach the printer sheet 340 to the print bed 130 of the 3D printer and the means are not particularly limited, so long as the printer sheet can be disposed smoothly without wrinkles, folds or ridges on the surface of the printer sheet 340 in contact with the print bed 130 of the 3D printer and/or the surface on which the 3D printing process takes place and on which the 3D printed object is formed. In some embodiments, the fastening means 350 may include a layer of adhesive or tape on the surface of the printer sheet disposed in contact with the print bed of the 3D printer. The adhesive should be such that it holds the printer sheet securely and stationary on the print bed of the 3D printer during the 3D printing process, yet permit easy removal of the printer sheet including the 3D printed object formed thereon from the print bed of the 3D printer following completion of the print job, without damaging or destroying the 3D printed object. In some embodiments, the fastening means 350 may include a cover for the adhesive on the surface of the printer sheet disposed in contact with the print bed of the 3D printer. The cover may be removed prior to fastening/attaching the printer sheet to the print bed of the 3D printer. The fastening means 350 may also be provided by a clip or clamp such that the printer sheet 340 may be clipped or clamped onto the print bed 130. For example, large binder clips configured to clip the printer sheet 340 to the print bed 130 may be used without departing from the scope of the present inventive concept. In further embodiments, the fastening means may be provided by a type of tape that tapes the printer sheet 340 to the print bed 130 of the 3D printer. In some embodiments, the tape may be two-sided tape attached to both the surface of the printer sheet and the print bed of the 3D printer. In some embodiments, the printer sheet 340 may be taped to the print bed 130 of the 3D printer by the edges of the printer sheet onto the print bed of the 3D printer. In still other embodiments, the fastening means may be a type of adhesive, for example, a non-permanent adhesive that provides secure attachment of the printer sheet 340 to the print bed 130 of the 3D printer during the print job, but permits easy removal of the printer sheet from the print bed 130 of the 3D printer after completion of the print job, leaving little or no residue on the print bed 130 following removal of the printer sheet. In yet other embodiments, the printer sheet 340 may “self-adhere” to print bed 130 of the 3D printer without the requirement of any additional fastening means or devices, and/or the printer sheet 340 may optionally include a means to facilitate removal of the printer sheet 340 from the print bed 130 of the 3D printer. Although the fastening means 350 are shown on opposite edges of the printer sheet 340 in FIG. 3, embodiments of the present inventive concept are not limited thereto. For example, the fastening means may be provided at more or less locations on the printer sheet and in some embodiments may not be visible outside the sides/edges of the printer sheet itself.

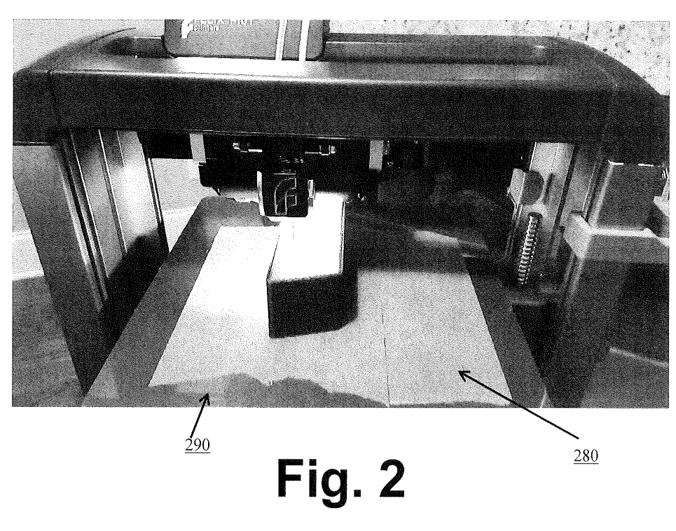

In some embodiments, the printer sheet 340 may include an adhesive disposed on the surface of the printer sheet on which the 3D printing process takes place and on which the 3D printed object is formed. The adhesive may be a water-soluble adhesive, for example, Elmer's glue or the like. In some embodiments, a layer of the adhesive disposed on the surface of the printer sheet on which the 3D printing process takes place and on which the 3D printed object is formed is substantially smooth and of even thickness such that impressions will not be transferred to the 3D printed object. For example, FIG. 2 illustrates a conventional method of painter's tape 280 on the print bed 290 of the 3D printer and a 3D printed object is secured to the painter's tape by a water soluble glue. This method may transfer unwanted impressions onto the 3D printed object as discussed above.

Adhesives in accordance with embodiments of the present inventive concept may be such that the 3D printed object being formed thereon is held securely and stationary in relation to the print bed of the 3D printer during the 3D printing process. Furthermore, the adhesive should be of a nature such that upon completion of the print job, the 3D printed object may be more easily removed from the printer sheet without damaging or destroying the 3D printed object. In some embodiments, the printer sheet may include a cover for the adhesive disposed on the surface of the printer sheet on which the 3D printing process takes place and on which the 3D printed object is formed, that is removed prior to the 3D print job. In further embodiments, the printer sheet may not have adhesive properties at room temperature, but upon heating the print bed before the 3D printing process begins to about 100 degrees Celsius, the adhesive properties of the printer sheet may be activated.

In some embodiments, the surface of the printer sheet on which the 3D printing process takes place and on which the 3D printed object is formed may include a material which effectively secures the 3D printed object in place during the 3D print job, but permits the easy removal of the 3D printed object after completion of the 3D print job from the printer sheet without damaging or destroying the 3D printed object. The material may include a texture or a roughness that facilitates the securing of the 3D printed object in place during the printing process.

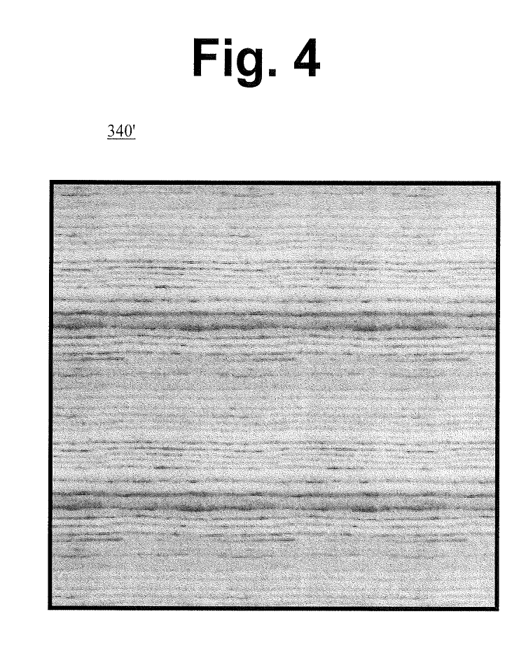

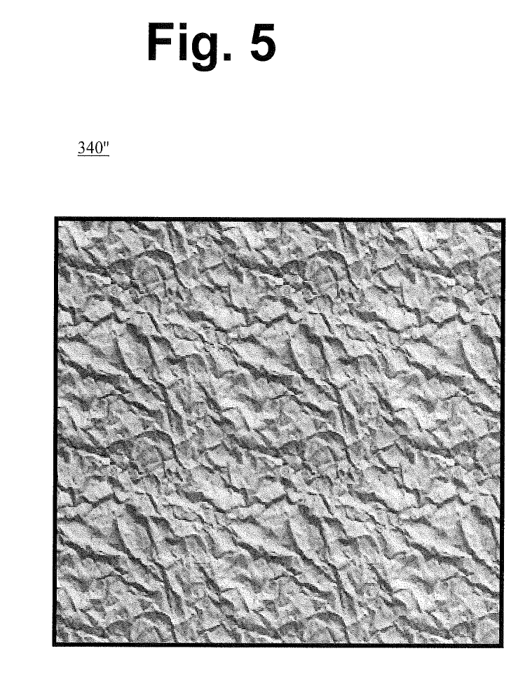

In some embodiments, a user may want a texture or design to be transferred to the object. As illustrated in FIGS. 4 and 5, in some embodiments, the printer sheet 340′ and 340″ may include a texture or design that is configured to transfer to the surface of the 3D printed object in contact with the printer sheet. Thus, as opposed to having a smooth surface, the printer sheet may include a desired texture, for example, but not limited to, wood grain, leather, parallel shallow grooves, zebra stripes, or even a turned metal finish. The texture provided on the printer sheet will be transferred to the surface of the 3D printed object in contact with the printer sheet. The textures illustrated in FIGS. 4 and 5 are provided as examples only and are not intended to limit the present inventive concept.

In some embodiments, the printer sheet in accordance with embodiments discussed herein may include a dye or coloring that may be transferred to the surface of the 3D printed object in contact with the printer sheet. In still other embodiments, the printer sheet of the inventive concept may be able to transfer a color pattern, for example, but not limited to, a single solid color, rainbow, zebra stripes, silver and/or chrome coloring, onto a surface of the 3D printed object in contact with the printer sheet. In yet other embodiments, the printer sheet of the inventive concept can transfer lettering and/or numbering, for example, rub-on transfer lettering, onto a surface of the 3D printed object in contact with the printer sheet. It will be understood that embodiments of the present inventive concept may have texture, color, patterns or any combination of these without departing from the scope of the present inventive concept.

As discussed briefly above, some embodiments provide a printer sheet that addresses many of the problems found in conventional methods of 3D printing. Some embodiments of the inventive concept may be a product for single use, i.e., is a consumable item that is disposed of following completion of the print job. As such, in some embodiments, the printer sheet of the inventive concept may be provided in a package, or the like, comprising a plurality of printer sheets. The number of sheets may be, for example, 1, 2, 3, 4, 5, 10, 15, 20, 25, 50, 100, 200, 500 or more, or any reasonable number of sheets. In some embodiments, the package comprising a plurality of printer sheets may include one embodiment discussed herein, or more than one of the various embodiments of the printer sheets as set forth herein, for example, printer sheets for securing a 3D printed object on the print bed of a 3D printer, printer sheets that may also transfer texture or design, printer sheets that may transfer a color pattern, or printer sheets that may transfer lettering, to the 3D printed object

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A printer sheet for securing printed objects to a print bed of a three-dimensional (3D) printer comprising a sheet of material configured to be secured to the print bed and provide consistent and even adhesion of a printed object to the print bed during printing and facilitate removal of the printed object upon completion of printing.

2. The printer sheet of claim 1, wherein the printer sheet comprises a first surface that contacts the print bed and a second surface that contacts the printed object, the printer sheet further comprising a fastening mechanism on the first surface of the printer sheet to secure the printer sheet to the print bed.

3. The printer sheet of claim 2, wherein the fastening mechanism comprises an adhesive on the first surface of the printer sheet.

4. The printer sheet of claim 3, wherein the adhesive on the first surface of the printer sheet comprises a removable cover thereon, the removable cover being configured to be removed before the printer sheet is secured to the print bed.

5. The printer sheet of claim 3, wherein the adhesive on the first surface of the printer sheet is activated by heat as the print bed is heated during printing.

6. The printer sheet of claim 5, wherein the adhesive is activated at a temperature of about 100 degrees Celsius.

7. The printer sheet of claim 1, wherein the printer sheet is secured to the print bed using a fastening means separate from the printer sheet.

8. The printer sheet of claim 7, wherein the fastening means comprises binder clips, clamps, adhesive tape and any combination thereof.

9. The printer sheet of claim 1, wherein the printer sheet is secured to the print bed using a self-adhesive property of the printer sheet.

10. The printer sheet of claim 1, wherein the printer sheet comprises a first surface that contacts the print bed and a second surface that contacts the printed object, further comprising an adhesive material on the second surface of the printer sheet that contacts the printed object and secures the printed object during printing.

11. The printer sheet of claim 1, wherein the printer sheet is a moderately flexible material.

12. The printer sheet of claim 1, wherein the material of the printer sheet comprises at least one of a polymeric material, a plastic material, a polycarbonate material and a polymide material.

13. The printer sheet of claim 1, wherein the printer sheet is any size and shape smaller than the print bed.

14. The printer sheet of claim 1, wherein a size of the printer sheet is customizable.

15. The printer sheet of claim 1, wherein the printer sheet is configured to be used a limited number of times.

16. The printer sheet of claim 1, wherein the printer sheet is heat resistant.

17. The printer sheet of claim 1, wherein, when secured to the print bed, the printer sheet is smooth with no folds, wrinkles or ridges.

18. The printer sheet of claim 1:
wherein the printer sheet comprises a first surface that contacts the print bed and a second surface that contacts the printed object; and
wherein the second surface comprises at least one of a color, texture, design, letter and number that is configured to be transferred to the printed object during printing.

19. The printer sheet of claim 1, wherein a plurality of printer sheets are combined together in a package to be purchased by a user of the 3D printer.
